(19) United States
(12) Patent Application Publication
(10) Pub. No.: US 2023/0108854 A1
(43) Pub. Date: Apr. 6, 2023

(54) DYNAMICALLY UPDATING NETWORK ROUTES

(71) Applicant: Pulse Secure, LLC, San Jose, CA (US)

(72) Inventors: Amit Kumar Namdev, Jabalpur (IN); Meera Mohideen, Aranthangi (IN); Vagish Kalligudd, Bangalore (IN)

(73) Assignee: Pulse Secure, LLC, San Jose, CA (US)

(21) Appl. No.: 17/812,006

(22) PCT Filed: Jan. 13, 2021
(86) PCT No.: PCT/US2021/013275

§ 371 Date: Jul. 12, 2022

(30) Foreign Application Priority Data
Jan. 13, 2020 (IN) 202041001451

(51) Int. Cl. H04L 9/40; H04L 61/4511; H04L 12/46

(52) U.S. Cl. CPC H04L 63/0272; H04L 12/4633; H04L 61/4511; H04L 63/164

(57) ABSTRACT

An example endpoint device includes one or more processors configured to allocate a range of IP addresses to use for fully qualified domain name (FQDN)-based tunnel splitting; send a DNS query to a DNS server; receive a DNS response from the DNS server; modify a first IP address in the DNS response to one of the allocated IP addresses; associate the first IP address and the one of the allocated IP addresses in a data table; change a destination address that corresponds to the one of the allocated IP addresses in a first TCP packet received from a user application to be the first IP address; and in response to receiving, from a gateway, a second TCP packet with a source address that corresponds to the first IP address, change a source address in a second TCP packet to be the one of the allocated IP addresses.

This application claims priority to India Patent Application No. 202041001451, filed Jan. 13, 2020, the entire contents of which are hereby incorporated by reference.

### TECHNICAL FIELD

The techniques described herein relate to systems, software, and methods for handling network traffic.

### BACKGROUND

Layer 3 fully qualified domain name (FQDN) based split tunneling is typically performed by dynamic per-IP routing or a kernel mode driver. When attempting to perform Layer 3 FQDN based split tunneling on mobile devices, mobile device manufacturers prefer to isolate virtual private network (VPN) clients installed on mobile platforms. That is, these clients are often sandboxed on the mobile device. This forces the VPN clients to only route data packets exiting from the mobile device over a VPN socket, to direct the data packets to a private network gateway for further processing. The VPN tunnel is a secure connection. Each of the VPN clients and the private network gateway operate to encrypt data packets that pass from the mobile computing device to the private network gateway and that pass from the private network gateway to the mobile computing device.

### SUMMARY

In general, the techniques described herein include systems and methods for controlling VPN traffic using fully qualified domain names (FQDNs). More specifically, the techniques described in this disclosure include dynamically updating network routes based on FQDN rules in IP-based routes for a Layer 3 (L3) VPN tunnel. In this disclosure, “Layer N” refers to the Nth layer of the Open Systems Interconnection (OSI) network model.

In Layer 3, some mobile operating system (mOS) platforms provide a virtual tunnel interface where VPN clients can set IP-based routes for receiving IP traffic to be tunneled. However, mOS platforms do not allow setting FQDNs for splitting traffic. Hence, existing VPN clients operating on these mOS platforms are incapable of handling FQDNs for split-tunneling IP traffic. Some mOS platforms support FQDN based split tunneling in Layer 4. However, this requires mobile device management (MDM) support in Layer 4. Further, a Layer 4 VPN tunnel is very limited and lacks many features of a Layer 3 VPN tunnel. Additionally, in an mOS, a tunnel interface is re-established when changing routes dynamically, which can interrupt the traffic flow or cause a communication session failure. As described below, the techniques of this disclosure allow FQDNs for split-tunneling Internet protocol (IP) traffic in Layer 3 on mOS client devices. A VPN client operating on a mobile device designates an IP address range to be used by the VPN client to establish a plurality of dynamic network routes corresponding network tunnels. The VPN client may pre-select IP addresses from a range IP address ranges that are restricted for use as private IP addresses, eg., in local networks, in VPNs, etc. The restricted range of IP addresses is received to allow setting FQDN’s for splitting IP traffic.

In one example, a method includes allocating, by a virtual private network (VPN) client executing on an endpoint device, a range of IP addresses to use for fully qualified domain name (FQDN)-based tunnel splitting; sending, by the VPN client, a DNS query to a DNS server; receiving, by the VPN client, a DNS response from the DNS server; modifying, by the VPN client, a first IP address in the DNS response to one of the allocated IP addresses; associating, by the VPN client, the first IP address and the one of the allocated IP addresses in a data table; in response to receiving, from a user application executing on the endpoint device, a first TCP packet with a destination address that corresponds to the one of the allocated IP addresses, changing the destination address in the first TCP packet to be the first IP address; and in response to receiving, from a gateway, a second TCP packet with a source address that corresponds to the first IP address, changing the source address in the second TCP packet to be the one of the allocated IP addresses.

In another example, an endpoint device includes one or more processors implemented in circuitry and configured to: allocate a range of IP addresses to use for fully qualified domain name (FQDN)-based tunnel splitting; send a DNS query to a DNS server; receive a DNS response from the DNS server; modify a first IP address in the DNS response to one of the allocated IP addresses; associate the first IP address and the one of the allocated IP addresses in a data table; in response to receiving, from a user application executing on the endpoint device, a first TCP packet with a destination address that corresponds to the one of the allocated IP addresses, change the destination address in the first TCP packet to be the first IP address; and in response to receiving, from a gateway, a second TCP packet with a source address that corresponds to the first IP address, change the source address in the second TCP packet to be the one of the allocated IP addresses.

In another example, an endpoint device includes means for allocating a range of IP addresses to use for fully qualified domain name (FQDN)-based tunnel splitting; means for sending a DNS query to a DNS server; means for receiving a DNS response from the DNS server; means for modifying a first IP address in the DNS response to one of the allocated IP addresses; means for associating the first IP address and the one of the allocated IP addresses in a data table; means for changing, in response to receiving a first TCP packet with a destination address that corresponds to the one of the allocated IP addresses from a user application executing on the endpoint device, the destination address in the first TCP packet to be the first IP address; and means for changing, in response to receiving a second TCP packet with a source address that corresponds to the first IP address from a gateway, the source address in the second TCP packet to be the one of the allocated IP addresses.

In another example, a computer-readable storage medium has stored thereon instructions that, when executed, cause a processor of an endpoint device and executing a virtual private network (VPN) client to allocate a range of IP addresses to use for fully qualified domain name (FQDN)-based tunnel splitting; send a DNS query to a DNS server; receive a DNS response from the DNS server; modify a first IP address in the DNS response to one of the allocated IP addresses; associate the first IP address and the one of the allocated IP addresses in a data table; in response to receiving, from a user application executing on the endpoint device, a first TCP packet with a destination address that corresponds to the one of the allocated IP addresses, change the destination address in the first TCP packet to be the first IP address; and in response to receiving, from a gateway, a second TCP packet with a source address that corresponds to the first IP address, change the source address in the second TCP packet to be the one of the allocated IP addresses.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

The features of the present disclosure will best be understood from a detailed description of the techniques and examples thereof selected for the purposes of illustration and shown in the accompanying drawings in which:

FIG. 1 is a block diagram illustrating an example endpoint device with a VPN client that operates in accordance with the techniques of this disclosure.

FIG. 2 is a block diagram illustrating an example system to dynamically update network routes in IP-based routes for Layer 3 VPN tunneling that operates in accordance with the techniques of this disclosure.

FIG. 3 is a flow diagram illustrating an example method of using dynamically updating network routes in IP-based routes for Layer 3 VPN tunneling on an endpoint device in accordance with the techniques of this disclosure.

FIG. 4 is a flowchart illustrating an example method for configuring fully qualified domain name (FQDN) tunnel splitting according to the techniques of this disclosure.

FIG. 5 is a flowchart illustrating an example method for sending data received from an application via a VPN tunnel according to the techniques of this disclosure.

FIG. 6 is a flowchart illustrating an example method for receiving a packet and forwarding data to an application according to the techniques of this disclosure.

These and other aspects and advantages will become apparent when the description below is read in conjunction with the accompanying drawings.

### DETAILED DESCRIPTION

In general, the techniques described herein include utilizing fully qualified domain names (FQDNs) to facilitate dynamically updating network routes in IP-based routes for Layer 3 virtual private network (VPN) tunneling. Using these techniques, a mobile device, such as a VPN client executing on the mobile device (or other endpoint device), can tunnel network traffic using a VPN between the mobile device and a server device, e.g., a server device associated with a particular web domain, in particular, a fully qualified domain name. Conventional VPN clients are generally not capable of providing FQDNs for VPN tunnels at Layer 3. Layer 3 VPN tunnels provide security and a high quality of service. Thus, the techniques of this disclosure may improve performance of traffic through a network, e.g., thereby reducing latency in both client-to-server and server-to-client network communications, and/or increasing security of such network communications.

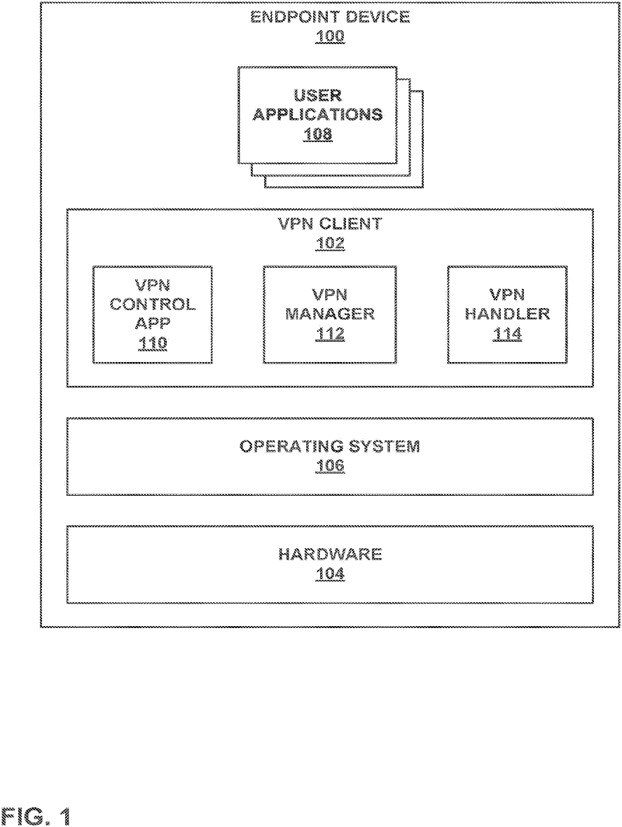

FIG. 1 is a block diagram illustrating an example endpoint device 100 with a virtual private network (VPN) client 102 that operates in accordance with the techniques of this disclosure. Endpoint device 100 may be any device with a mobile operating system (mOS), such as a smartphone, a wearable device a tablet, or a smartwatch, etc. Endpoint device 100 include hardware 104. Hardware 104 includes, for example, a mobile microprocessor, a memory device in communication with the mobile microprocessor, a wireless network interface device that includes a transmitter and a receiver, and/or one or more input/output interfaces that may include power and various data interfaces. In this example, endpoint device 100 also includes an operating system 106 (e.g., a mobile operating system) operating on hardware 104 (e.g., the mobile microprocessor and memory) and a plurality of user applications 108 installed and stored on the mobile memory. Processing devices implemented in circuitry of hardware 104 may execute instructions for applications 108 stored on the mobile memory. Additionally, endpoint device 100 may utilize cloud-based user applications locally using local modules corresponding with the cloud-based applications. Endpoint device 100 may then exchange data corresponding with the cloud-based applications with various network-based appliances, e.g., based on a private network or on another network. The mobile operating system (mOS) 106 includes an operating system interface module comprising software resources operating on the mobile microprocessor to provide an interface between the mOS 106 and the user applications 108. The operating system interface module coordinates allocation of resources of endpoint device 100 to the user applications 108 according to policies, rules, and other control features of the endpoint device and the operating system.

Endpoint device 100 includes VPN client 102, which may be installed and stored in memory. In other examples, VPN client 102 may be implemented in hardware, such as an application-specific integrated circuit (ASIC), field programmable gate array (FPGA), digital signal processor (DSP), or the like. In this example, VPN client 102 includes VPN control application 110, VPN security manager 112, and VPN tunnel handler 114. VPN client 102 is configured to manage network communications between the mobile computing device and a private network. VPN security manager 112 and VPN tunnel handler 114 operate to establish a VPN tunnel between the wireless network interface device operating on endpoint device 100 and a network gateway corresponding to the private network. Other destinations of the private network or resources of the private network are useable as the destination of the VPN tunnel.

VPN client 102 is configured to encrypt network traffic exiting the mobile computing device and to modify data packets corresponding with the encrypted network traffic to ensure that the encrypted network traffic reaches the network gateway corresponding with the private network, (over the VPN tunnel) and to ensure that any reply data traffic corresponding with the network traffic exiting the mobile computing device is routed back to the mobile computing device. The network gateway, or other resource corresponding with the private network, is configured to encrypt network traffic destined for the mobile computing device before routing the encrypted network traffic to the mobile computing device using a VPN tunnel. The encrypted network traffic destined for the mobile computing device includes reply data traffic in response to network traffic exiting the mobile computing device as well as network traffic related to operating the private network such as security policy updates, access control list (ACL) updates, and availability of alternate network gateways corresponding with the private network that could be used to access services of the private network.

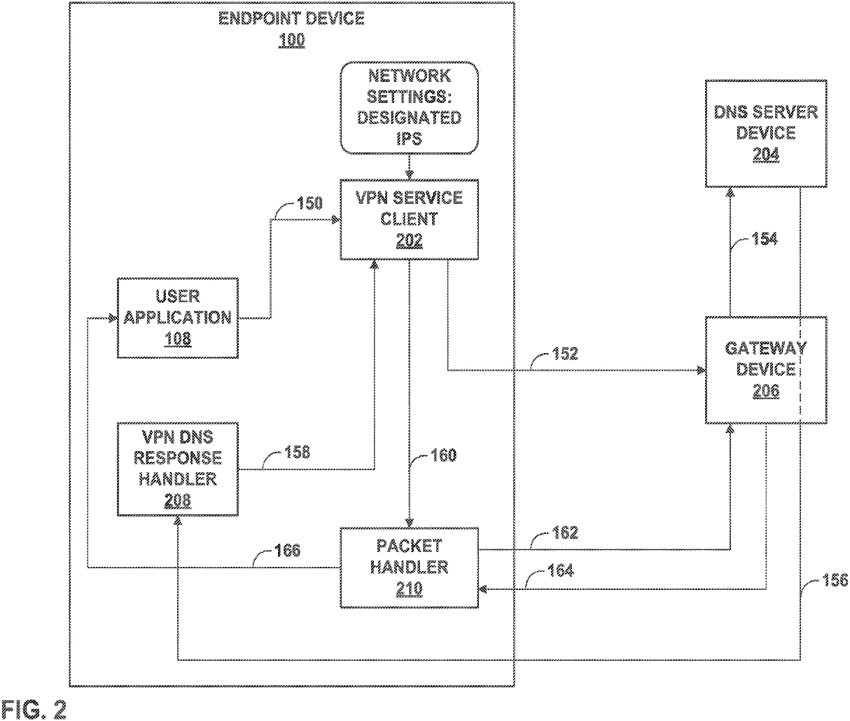

FIG. 2 is a block diagram illustrating an example system 200 configured to dynamically update network routes in IP-based routes for Layer 3 VPN tunneling that operates in accordance with the techniques of this disclosure. Several steps for dynamically update network routes are described below. VPN service client 202 (e.g., VPN control application 110, VPN security manager 112, and VPN tunnel handler 114 of FIG. 1) operating on endpoint device 100 designates a range of private IP addresses for use as IP-based routes for receiving IP traffic to be tunneled in Layer 3. The IP traffic to be tunneled may include IP traffic corresponding with (i) one or more applications (e.g., user applications 108 of FIG. 1) operating on endpoint device 100, (ii) IP traffic being routed to selected destination IP addresses (e.g., FQDNs), or (iii) IP traffic designated to be encrypted. In some examples, endpoint device 100 includes various network policy enforcement points configured to enforce network policies corresponding with determining which IP traffic types should be routed to destination addresses over a VPN tunnel and which IP traffic types should be routed to destination addresses over public networks without VPN tunneling. As discussed herein. IP packets routed over a network tunnel may be encrypted by the source endpoint and decrypted by the destination endpoint In addition, reply IP packets that are received in response to IP packets routed to a destination endpoint address over a network tunnel may be routed back to the endpoint device over a network tunnel and encryption by the destination endpoint and decryption by the source endpoint. Thus, one criterion that may be applied when selecting which IP traffic types to route to destination addresses over a VPN tunnel is whether the packets being routed should be encrypted.

Example private IPv4 IP address ranges are shown on Table 1 below. Each range may include at least a portion thereof that can be selected for split-tunneling IP traffic using a FQDN setting as described below.

TABLE 1

| | |
|---|---|
| IPv4 Exemplary IP Address Ranges | Prefix |
| 10.0.0.0 thru 10.255.255.255 | 10/8 |
| 172.16.0.0 thru 172.31.255.255 | 172.16/12 |
| 192.168.0.0 thru 192.168.255.25 | 192.168/16 prefix |

Example IPv6 IP address ranges can be selected from fc00::/7 by designating a unique local address (e.g., ranging from fc00:0000:0000:0000:0000:0000:0000:0000 to fdff:ffff:ffff:ffff:ffff:ffff:ffff:ffff) for split-tunneling IP traffic using a FQDN setting.

VPN service client 202 selects the range of IP addresses to be used for split-tunneling IP traffic using FQDN settings. VPN service client 202 selects a range of local or private IP addresses that are not in use by determining the IP address designated to the local gateway and the IP address range designated to the local network and then by selecting an IP address range that is not in use by the local network or the local gateway. In an IPv4 example, when the gateway IP address range starts with 10.x.x.x and the local network IP starts with 172.x.x.x, then the IP range starting from 192.x.x.x can be associated with tunneling routes. For example, VPN service client 202 may select a range from 192.168.0.1 to 192.168.1.225. In an IPv6 example, when the gateway IP address range is between: :fc00:0000:0000:0000:0000:0000:0000:0000 and fc:00:0000:0000:0000:ffff:ffff:ffff:ffff, then the IP range starting fc00:0000:0000:001 to :ffff:ffff:ffff:ffff- can be associating with tunneling routes.

After selecting the IP address range for local gateway for split-tunneling IP traffic using a FQDN, VPN service client 202 sets the domain name system (DNS) IP in includeRoutes to add to DNS packets from tunnel interface. The following is an example of setting the DNS IP in includeRoutes.

_networkSettings. IPv4Settings.includedRoutes
= @[[[NEIPv4Route alloc] initWithDestinationAddress:@”8.8.8.8” subnetMask:@”
2.55.255.255.0”],
[[NEIPv4Route alloc]
initWithDestinationAddress:@” 192.168.0.0” subnetMask:@”
255.255.254.0”]];

VPN service client 202 adds a match domain in the DNS setting so endpoint device 100 gets DNS packets for the matchDomains. The following is an example of configuring VPN service client 202 to selection DNS packets in a virtual interface for the domain name “example.com.” Other domains are routed through the actual DNS server.

_networkSettings.DNSSettings
= [[NEDNSSettings alloc] initWithServers:@[@” 8.8.8.8”]];
_networkSettings.DNSSettings. matchDomains = @[@” example.com”];

In this example, VPN service client 202 reads a DNS packet from the virtual interface when a user navigates to “example.com” and a DNS query is sent to gateway device 206. When gateway device 206 returns a DNS response, packet handler 210 parses the response. Furthermore, packet handler 210 updates the IP address returned in the DNS response to an IP address for split-tunneling IP traffic (i.e., one of the pre-determined IP addresses in the allocated range of IP addresses). For example, “example.com” may resolve with IP = 142.10.2.0, and packet handler 210 may update the IP address with IP = 192.168.0.0 (one of the pre-allocated IP address for split tunneling). Packet handler 210 keeps a mapping of pre-allocated and original IP in a dictionary stored in local memory, e.g., a data table stored in memory of hardware 104 (FIG. 1).

After modifying the IP traffic for split tunneling, VPN service client 202 may update the IP header and UDP checksum. After updating the DNS response, a virtual interface may receive the DNS response. The virtual interface starts sending the TCP/UDP packets for, in this example, example.com and will get packets with destination IP address =192.168.0.0 (since example.com was assigned 192.168.0.0 and was already added into the included routes).

For TCP/UDP outbound packets, VPN service client 202 rewrites the packet destination address with the actual IP address (e.g., 142.10.2.0) using the stored mapping data. VPN service client 202 may then update a checksum for the packet, then send the updated packet to gateway device 206. For example, if the received destination address is 192.168.0.0, then VPN service client 202 may update the destination address to 142.10.2.0. For TCP/UDP inbound packets, VPN service client 202 rewrites the packet source address with the pre-allocated IP (e.g., 192.168.0.0) using the mapping data and recalculates the checksum. For example, if the received source address = 142.10.2.0, then VPN service client 202 may update the source address to 192.168.0.0.

Endpoint device 100 includes one or more applications (e.g., the user applications 108). For example, the application may be an internet browser that is used to establish communication sessions with local or non-local network devices. VPN service client 202 operates on endpoint device 100 to intercept IP traffic exiting from one or more applications 108 and to determine if the exiting IP traffic meets the requirements for split tunneling.

In a first step (150), VPN service client 202 intercepts the IP packets exiting from application 108. VPN service client 202 is configured with network settings or policies including the range of IP addresses designated for split-tunneling IP traffic using a FQDN setting (as described above), as well as a list of domain names designated for spit-tunneling. VPN service client 202 may also be configured with other policy or network settings that correspond to initiating a split tunnel or simply routing the IP traffic without tunneling. Upon receiving IP traffic from application 108, VPN client service 202 (i) determines the FQDN corresponding with TPC or UDP traffic, (ii) determines if the IP traffic should be tunneled, and (iii) initiates a DNS query to look up the IP address presently assigned to each FQDN.

In a second step (152), VPN service client 202 sends the DNS query to a DNS server 204 through a local gateway device 206.

In a third step (154), local gateway device 206 sends the DNS query to DNS server 204.

In a fourth step (156), DNS server 204 sends a DNS response to endpoint device 100 via local gateway 206. VPN DNS response handler 208 of endpoint device 100 intercepts the DNS response from local gateway device 206. In cases where the FQDN or the IP address corresponding with the DNS response is qualified for spilt-tunneling, VPN DNS response handler 208 changes the DNS response. In particular, when the IP traffic is to be routed to its destination over a split tunnel, VPN DNS response handler 208 modifies the DNS response to change the destination IP address of the packet from the IP address corresponding with the FQDN of the DNS query to an IP address corresponding with the range of IP addresses designated for split-tunneling IP traffic using a FQDN setting.

In a fifth step (158), VPN DNS response handler 208 sends the modified IP traffic through VPN service client 202

In a sixth step (160), VPN service client 202 sends the modified packet to packet handler 210. VPN DNS response handler 208 stores the DNS response information in a local memory as well as the specific split tunneling IP address assigned to the IP traffic. Packet handler 210 accesses the stored DNS response information.

In a seventh step (162), when packet handler 210 reads a packet destination IP address corresponding to the range of IP addresses designated for split-tunneling IP traffic, packet handler 210 sets up a tunnel between packet handler 210 and the destination IP address read from the DNS response If packet handler 210 reads a packet destination IP address that does not correspond with IP addresses designated for split-tunneling IP traffic using a FQDN setting, packet handler 210 simply routes the packet to the destination IP address without tunneling.

In an eighth step (164), reply data packets received in response to the sent data packets are received through local gateway device 206 and intercepted by packet handler 210. Packet handler 210 then determines if the incoming packet was received over a VPN tunnel or not by determining if the source IP address of the reply packet corresponds an IP address corresponding with the range of IP addresses designated for split-tunneling IP traffic using a FQDN setting. If yes, packet handler 210 modifies the reply packet to change its source IP address to the IP address associated with the FQDN that was provided in the DNS response. If no, packet handler 210 does not modify the packet.

In a ninth step (166), packet handler 210 routes the received packet to application 108 where the IP traffic was initiated.

In this manner, endpoint device 100 of FIGS. 1 and 2 represents an example of an endpoint device including one or more processors implemented in circuitry and configured to: allocate a range of IP addresses to use for fully qualified domain name (FQDN)-based tunnel splitting, send a DNS query to a DNS server, receive a DNS response from the DNS server; modify a first IP address in the DNS response to one of the allocated IP addresses; associate the first IP address and the one of the allocated IP addresses in a data table; in response to receiving, from a user application executing on the endpoint device, a first TCP packet with a destination address that corresponds to the one of the allocated IP addresses, change the destination address in the first TCP packet to be the first IP address; and in response to receiving, from a gateway, a second TCP packet with a source address that corresponds to the first IP address, change the source address in the second TCP packet to be the one of the allocated IP addresses.

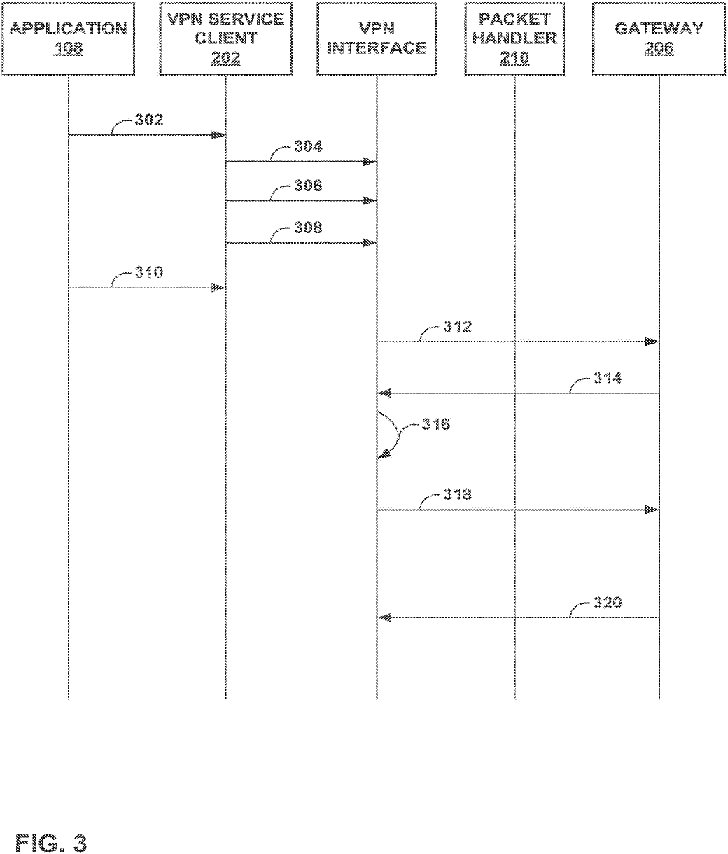

FIG. 3 is a flow diagram illustrating an example method of using dynamically updating network routes in IP-based routes for Layer 3 VPN tunneling on an endpoint device according to the techniques of this disclosure. Initially, one of the applications 108 (e.g., a web browser) starts a VPN tunnel (302). VPN service client 202 adds a DNS server (e.g., 8.8.8.8) and a match domain (e.g., example.com) in the DNS settings (304) of the VPN interface. VPN service client 202 assigned pre-allocated IP addresses (e.g., 192.168.0.0 to 192.168.1.255) as included routes (306) in the VPN interface. VPN service client 202 assigns the DNS server (e.g., 8.8.8.8) as included routes (308) in the VPN interface.

Subsequently, application 108 browses the domain (e.g., examplecom) (310). Application 108 may, for example, initially submit a DNS request for the domain. The VPN interface transmits the DNS request to local gateway device 206 (312). Local gateway device 206 transmits a DNS response from the DNS server to the VPN interface (314). The VPN interface updates the DNS IP to one of the pre-allocated IP addresses (e.g., 192.168.0.0) and stores the actual IP address and the designated IP address in a map (316). The VPN interface sends a TCP packet to a local gateway 206 via packet handler 210 (318). Packet handler 210 updates the destination IP address in the packet (e.g., 192.168.0 0) to the actual IP address. Local gateway device 206 sends a TCP packet to the VPN interface via packet handler 210 (320). Packet handler 210 updates the destination IP address in the packet (e.g., the actual IP address) with the updated destination IP address (e.g., 192.168.0.0).

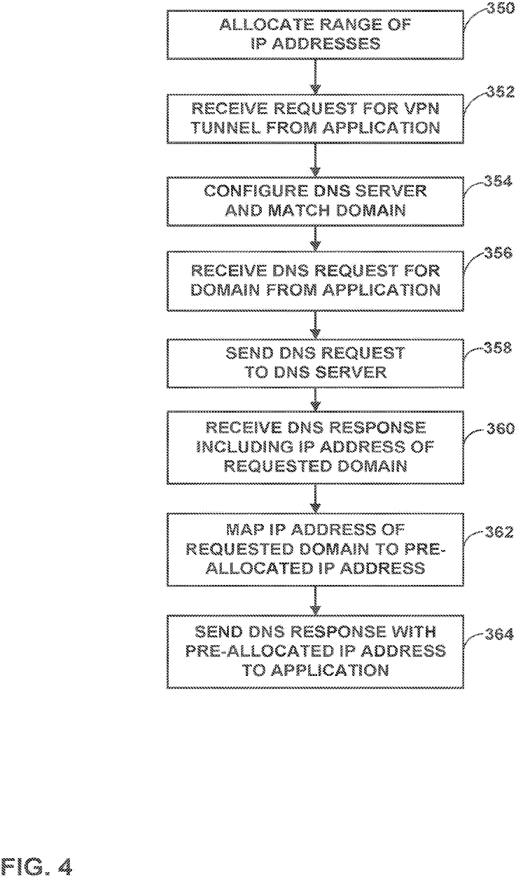

FIG. 4 is a flowchart illustrating an example method for configuring fully qualified domain name (FQDN) tunnel splitting according to the techniques of this disclosure. The method of FIG. 4 is explained with respect to VPN service client 202 of FIG. 2 for purposes of example. However, it should be understood that other units may be configured to perform this or a similar method, such as VPN client 102 of FIG. 1.

Initially, VPN service client 202 may allocate a range of IP addresses that may be used for fully qualified domain name (FQDN)-based tunnel splitting (350). VPN service client 202 may subsequently receive a request for a VPN tunnel from an application (352), such as a web browser. The application may be one of applications 108 of FIG. 1 or FIG. 2. VPN service client 202 may configure data for a DNS server and match domain in response to receiving the request from the application (354)

VPN service client 202 may then receive a DNS request for a domain from the application (356). VPN service client 202 may forward the DNS request to the DNS server according to the configuration data (358). VPN service client 202 may intercept a DNS response from the DNS server, where the DNS response includes an IP address of the requested domain (360). VPN service client 202 may map the IP address of the requested domain to one of the pre-allocated IP addresses in the allocated range of IP addresses (362). In this manner, VPN service client 202 may determine that packets destined for the IP address specified in the DNS response are to be forwarded via a network tunnel. VPN service client 202 may store data representing the mapping between the pre-determined IP address and the IP address specified in the DNS response. Furthermore, VPN service client 202 may also store data representative of an identifier for the application along with the pre-determined IP address and the IP address specified in the DNS response and use this data to determine an application to which to send data received from the IP address specified in the DNS response. VPN service client 202 may also modify the DNS response to replace the original IP address received from the DNS server with the pre-determined IP address, and send the DNS response with the pre-allocated IP address to the application (364).

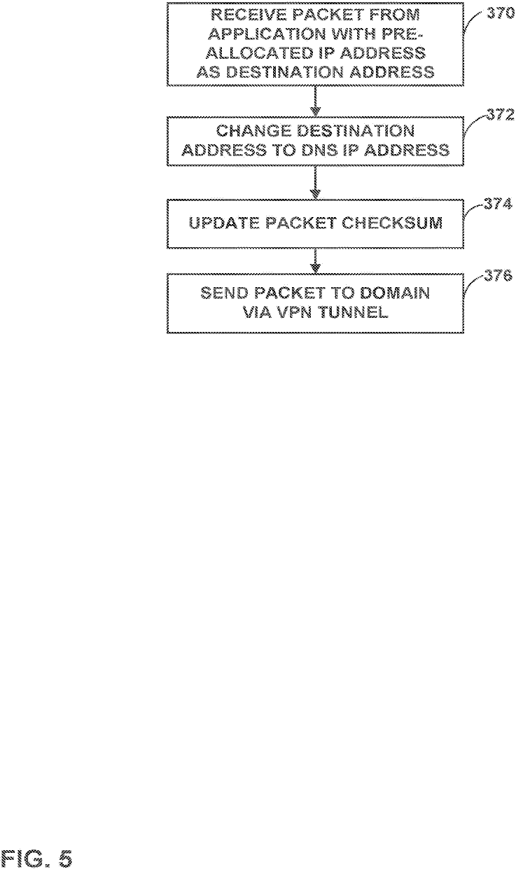

FIG. 5 is a flowchart illustrating an example method for sending data received from an application via a VPN tunnel according to the techniques of this disclosure. After performing the method of FIG. 4, VPN service client 202 may receive a packet from the application with the pre-allocated IP address as a destination address (370). VPN service client 202 may change the destination address to the DNS IP address (382), that is, the IP address specified in the original DNS response. In particular, VPN service client 202 may perform a lookup in the mapping data using the destination address, which corresponds to one of the range of pre-allocated IP addresses. The mapping data may associate the one of the range of pre-allocated IP addresses with the original DNS IP address received from the DNS server.

After changing the destination address to the original DNS IP address, VPN service client 202 may recalculate and update a checksum for the packet (374). VPN service client 202 may then send the packet to the domain (that is, toward the IP address) via a VPN tunnel (376).

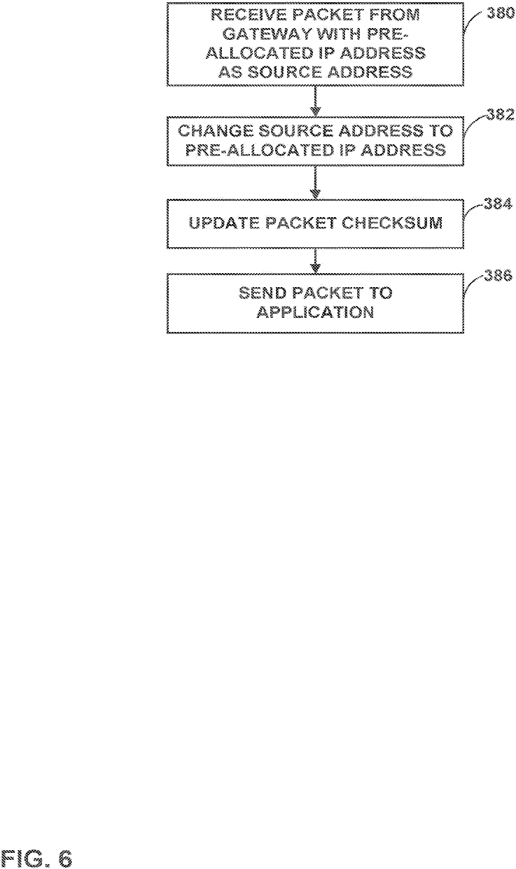

FIG. 6 is a flowchart illustrating an example method for receiving a packet and forwarding data to an application according to the techniques of this disclosure. After performing the method of FIG. 4, VPN service client 202 may receive a packet from a gateway, such as gateway device 206 (FIG. 2) including the DNS IP address as a source address (380). VPN service client 202 may perform a lookup on the DNS IP address in the mapping data and determine that an application to which to forward data of the packet is the application for the tunnel. VPN service client 202 may also determine the pre-allocated IP address from the mapping data from the DNS IP address specified in the received packet.

Thus, VPN service client 202 may change the source address of the received packet to the pre-allocated IP address (382). VPN service client 202 may also recalculate and update a checksum of the packet (384). VPN service client 202 may then send the packet toward the application (386) In particular, VPN service client 202 may send the packet to operating system 106 (FIG. 1), which may pass the packet through a network stack to unpack application-layer data from the packet and to determine the application (e.g., application 108) as the destination application of the packet.

In this manner, the methods of FIGS. 4-6 collectively represent an example of a method including allocating, by a virtual private network (VPN) client executing on an endpoint device, a range of Internet protocol (IP) addresses to use for fully qualified domain name (FQDN)-based tunnel splitting; sending, by the VPN client, a DNS query to a DNS server; receiving, by the VPN client, a DNS response from the DNS server; modifying, by the VPN client, a first IP address in the DNS response to one of the allocated IP addresses; associating, by the VPN client, the first IP address and the one of the allocated IP addresses in a data table; in response to receiving, from a user application executing on the endpoint device, a first TCP packet with a destination address that corresponds to the one of the allocated IP addresses, changing the destination address in the first TCP packet to be the first IP address; and in response to receiving, from a gateway, a second TCP packet with a source address that corresponds to the first IP address, changing the source address in the second TCP packet to be the one of the allocated IP addresses.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The terms “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media. Computer readable storage media, which is tangible and non-transitory, may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. It should be understood that the term “computer-readable storage media” refers to physical storage media, i.e., non-transitory storage media, and not signals, carrier waves, or other transitory media.

Various examples have been described. These and other examples are within the scope of the following claims.

1. A method comprising:
allocating, by a virtual private network (VPN) client executing on an endpoint device, a range of Internet protocol (IP) addresses to use for fully qualified domain name (FQDN)-based tunnel splitting;
sending, by the VPN client, a DNS query to a DNS server;
receiving, by the VPN client, a DNS response from the DNS server;
modifying, by the VPN client, a first IP address in the DNS response to one of the allocated IP addresses;
associating, by the VPN client, the first IP address and the one of the allocated IP addresses in a data table, the associating includes storing a mapping between the first IP address and the one of the allocated IP addresses in a memory including the data table;
in response to receiving, from a user application executing on the endpoint device, a first TCP packet with a destination address that corresponds to the one of the allocated IP addresses:
changing the destination address in the first TCP packet to be the first IP address; and
after changing the destination address in the first TCP packet to be the first IP address, sending the first TCP packet along a network route toward the destination address via a VPN tunnel.

2. (canceled)

3. The method of claim 1, further comprising, after changing the destination address in the first TCP packet to be the first IP address, updating a checksum for the first TCP packet.

4. The method of claim 1, further comprising, in response to receiving, from a gateway, a second TCP packet with a source address that corresponds to the first IP address, changing the source address in the second TCP packet to be the one of the allocated IP addresses.

5. The method of claim 4, further comprising, after changing the source address in the second TCP packet to be the one of the allocated IP addresses;
updating a checksum for the second TCP packet; and
sending data of the second TCP packet to the user application.

6. (canceled)

7. The method of claim 4, further comprising determining that the second TCP packet was received via a VPN tunnel when a source IP address of the second TCP packet corresponds to one of the allocated IP addresses.

8. The method of claim 1, further comprising:
receiving the DNS query from the user application; and
sending the DNS response including the one of the allocated IP addresses to the user application.

9. (canceled)

10. An endpoint device comprising one or more processors implemented in circuitry and configured to:
allocate a range of IP addresses to use for fully qualified domain name (FQDN)-based tunnel splitting;
send a DNS query to a DNS server;
receive a DNS response from the DNS server;
modify a first IP address in the DNS response to one of the allocated IP addresses;
associate the first IP address and the one of the allocated IP addresses in a data table, wherein the associating the first IP address and the one of the allocated IP addresses includes storing a mapping between the first IP address and the one of the allocated IP addresses in a memory including the data table;
in response to receiving, from a user application executing on the endpoint device, a first TCP packet with a destination address that corresponds to the one of the allocated IP addresses:
change the destination address in the first TCP packet to be the first IP address; and
after changing the destination address in the first TCP packet to be the first IP address, send the first TCP packet along a network route toward the destination address via a VPN tunnel.

11. The endpoint device of claim 10, wherein the one or more processors are configured to execute a virtual private network (VPN) client.

12. (canceled)

13. The endpoint device of claim 10, wherein the one or more processors are further configured to, after changing the destination address in the first TCP packet to be the first IP address, update a checksum for the first TCP packet.

14. The endpoint device of claim 10 wherein the one or more processors are further configured to, in response to receiving, from a gateway, a second TCP packet with a source address that corresponds to the first IP address, change the source address in the second TCP packet to be the one of the allocated IP addresses.

15. The endpoint device of claim 14, wherein the one or more processors are further configured to, after changing the source address in the second TCP packet to be the one of the allocated IP addresses:
update a checksum for the second TCP packet; and
send data of the second TCP packet to the user application.

16. (canceled)

17. The endpoint device of claim 14, wherein the one or more processors are further configured to determine that the second TCP packet was received via a VPN tunnel when a source IP address of the second TCP packet corresponds to one of the allocated IP addresses.

18. The endpoint device of claim 10, wherein the one or more processors are further configured to:
receive the DNS query from the user application; and
send the DNS response including the one of the allocated IP addresses to the user application.

19. The endpoint device of claim 10, wherein the endpoint device comprises a mobile device, a wearable device, a smartphone, a tablet, or a smartwatch.

20-30. (canceled)

31. A computer-readable storage medium comprising instructions that, when executed, cause a processor of an endpoint device and executing a virtual private network (VPN) client to:
allocate a range of IP addresses to use for fully qualified domain name (FQDN)-based tunnel splitting;
send a DNS query to a DNS server;
receive a DNS response from the DNS server;
modify a first IP address in the DNS response to one of the allocated IP addresses;
associate the first IP address and the one of the allocated IP addresses in a data table, wherein associating the first IP address and the allocated IP addresses includes storing a mapping between the first IP address and the one of the allocated IP addresses in a memory including the data table;
in response to receiving, from a user application executing on the endpoint device, a first TCP packet with a destination address that corresponds to the one of the allocated IP addresses:
change the destination address in the first TCP packet to be the first IP address; and
after changing the destination address in the first TCP packet to be the first IP address, send the first TCP packet along a network route toward the destination address via a VPN tunnel.

32. (canceled)

33. The computer-readable storage medium of claim 31 , further comprising instructions that cause the processor to, after changing the destination address in the first TCP packet to be the first IP address, update a checksum for the first TCP packet.

34. The computer-readable storage medium of claim 31 , further comprising instructions that cause the processor to, in response to receiving, from a gateway, a second TCP packet with a source address that corresponds to the first IP address, change the source address in the second TCP packet to be the one of the allocated IP addresses.

35. The computer-readable storage medium of claim 34, further comprising instructions that cause the processor to, after changing the source address in the second TCP packet to be the one of the allocated IP addresses:
update a checksum for the second TCP packet; and
send data of the second TCP packet to the user application.

36. (canceled)

37. The computer-readable storage medium of claim 34 , further comprising instructions that cause the processor to determine that the second TCP packet was received via a VPN tunnel when a source IP address of the second TCP packet corresponds to one of the allocated IP addresses.

38. The computer-readable storage medium of claim 31 , further comprising instructions that cause the processor to:
receive the DNS query from the user application; and
send the DNS response including the one of the allocated IP addresses to the user application.

39. (canceled)
